(19) United States
(12) Patent Application Publication
(10) Pub. No.: US 2022/0027670 A1
(43) Pub. Date: Jan. 27, 2022

(54) IMAGE GENERATION DEVICE, IMAGE GENERATION METHOD, AND PROGRAM

(71) Applicant: NIPPON TELEGRAPH AND TELEPHONE CORPORATION, Tokyo (JP)

(72) Inventors: Kaori KUMAGAI, Tokyo (JP); Yukito WATANABE, Tokyo (JP); Jun SHIMAMURA, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/312,314

(22) PCT Filed: Nov. 27, 2019
(86) PCT No.: PCT/JP2019/046324

§ 371 Date: Jun. 9, 2021

(30) Foreign Application Priority Data
Dec. 11, 2018 (JP) 2018-231866

(51) Int. Cl. G06K 9/62; G06K 9/46

(52) U.S. Cl. CPC G06K 9/6255; G06K 9/6256; G06K 9/46

(57) ABSTRACT

It is possible to generate an image of a desired category having a desired unique feature. A generation unit 3 generates a first image by associating a category feature that is a feature common to images belonging to a category obtained from a second image belonging to the same category as that of the first image with a unique feature that is a unique feature different between the first image and the second image.

### TECHNICAL FIELD

The present invention relates to an image generation device, an image generation method, and a program, and particularly to an image generation device, an image generation method, and a program for generating images having desired unique features.

### BACKGROUND ART

Due to digital cameras and smartphones becoming widespread in recent years, acquiring images has become easier, and by identification of objects in such images with machines, work efficiency of people has been able to be improved in various fields, such as in visual inspection by humans in factories, and automated detection of shortage of stock in retail stores, and the like.

Due to these circumstances, there is increasing demand for an image identification technology that enables objects in images to be identified by a machine.

Many methods based on a convolutional neural network (CNN), such as the one disclosed in Non Patent Literature 1 have been disclosed in recent years as image identification technologies.

A CNN iteratively carries out a convolution process in which a feature map created by applying filters for detecting features to input images while sliding is output and a pooling process in which the extracted features are summarized in each of local regions.

In order for the CNN to exhibit high identification performance, a large amount of training data needs to be input to the CNN and filters need to be trained to identify the data. That is, a large amount of training data is necessary to obtain a CNN with a highly accurate identification capability.

Manual preparation of such a large amount of training data incurs a very high cost. Specifically, to prepare training data for an image classification task of classifying images into categories, many images are needed for each category, and approximately 1200 images per category, that is, images for a total of 1,000 categories have been prepared in the dataset used in the image recognition competition “ILSVRC2012” based on the public dataset ImageNet for image classification tasks disclosed in, for example, Non Patent Literature 2. Furthermore, as a category is divided into more detailed categories (e.g., a case in which a chair category is divided into categories for sofa, bench, and dining chair), preparation of training data becomes more difficult.

To solve the above problems, there is a method of expanding image data by preparing a small amount of image data and converting the image data.

For example, according to Non Patent Literature 1, image data is expanded by using a predetermined geometric conversion method (cropping, rotation, or the like) for images, training of an image classifier is performed with the expanded image dataset, and thus improvement in image classification accuracy is recognized.

Furthermore, Patent Literature 1 and Non Patent Literature 3 propose a method for converting images based on features (attributes) that commonly exist in categories. A plurality of pieces of paired data of images and attributes of the images are prepared, and an image generation device is trained using the paired data as training data.

When a pair of an image and an attribute to be converted is input to the image generation device, an image having the attribute to be converted as a feature is output.

### CITATION LIST

### Patent Literature

Patent Literature 1: JP 2018-55384A

### Non Patent Literature

Non Patent Literature 1: C. Szegedy, Wei Liu. Y. Jia, P. Sermanet, S. Reed, D. Anguelov, D. Ethan, V. Vanhoucke, and A, Rabinovich, “Going Deeper with Convolutions,” In proc. IEEE Conference on Computer Vision and Pattern Recognition (CVPR), 2015, pp. 1-9.

Non Patent Literature 2: O. Russakovsky, J. Deng, H. Su, J. Krause, S. Satheesh, S. Ma, Z. Huang, A. Karpathy, A. Khosla, M. Bernstein, A. Berg, and L. Fei-Fei, “ImageNet Large Scale Visual Recognition Challenge,” In proc. International Journal of Computer Vision (IJCV), 2015, pp. 211-252.

Non Patent Literature 3: G. Lample, N. Zeghidour, N. Usunier, A. Bordes, L. Denoyer, and M. Ranzato, “Fader Networks: Manipulating Images by Sliding Attributes,” In Proc. of NIPS, 2017, pp. 5963-5972.

### SUMMARY OF THE INVENTION

### Technical Problem

However, because the image dataset obtained in Non Patent Literature 1 is limited to images obtained from geometric image conversions, there is a problem that images that are not obtained from geometric conversions are not likely to be correctly classified.

For example, because images having different colors and patterns are not obtained, an image having a color or a pattern that does not exist in a small image dataset is not likely to be correctly classified.

In addition, according to Non Patent Literature 3, although conversions can be variously performed based on attributes, an image to be converted is limited to an object of a category used for training of an image generation device. Thus, when an image of an unknown category that does not exist in training data used in training of the image generation device is to be converted, there is a problem that a location of the image at which a conversion is to be performed is not fixed and a first desired image is not obtained.

For example, in a case in which a category “cap” is an unknown category that does not exist in training data as shown in FIG. 8, it is difficult to ascertain which location on an image belonging to the “cap” category needs be converted.

The present invention has been conceived in view of the above-described points, and aims to provide an image generation device, an image generation method, and a program capable of generating an image of a desired category having a desired unique feature.

### Means for Solving the Problem

An image generation device according to the present invention is an image generation device configured to generate a first image having a desired unique feature, the image generation device including a generation unit configured to generate the first image by associating a category feature that is a feature common to images belonging to a category obtained from a second image belonging to the same category as that of the first image with a unique feature that is a unique feature different between the first image and the second image, and the unique feature is associated with the desired unique feature for a divided region obtained by dividing the second image.

In addition, an image generation method according to the present invention is an image generation method for generating a first image having a desired feature, the image generation method including generating, at a generation unit, the first image by associating a category feature that is a feature common to images belonging to a category obtained from a second image belonging to the same category as that of the first image with a unique feature that is a unique feature different between the first image and the second image, and the unique feature is associated with the desired unique feature for a divided region obtained by dividing the second image.

According to the image generation device and the image generation method according to the present invention, the generation unit generates a first image by associating a category feature that is a feature common to images belonging to the category obtained from a second image belonging to the same category as that of the first image with a unique feature that is a unique feature different between the first image and the second image. The unique feature is associated with a desired unique feature for each of divided regions obtained by dividing the second image.

As described above, by associating a category feature that is a feature common to images belonging to a category obtained from a second image belonging to the same category as that of the first image with a unique feature that is a unique feature different between the first image and the second image, the first image is generated, and thus the image of the desired category having a desired unique feature can be generated.

In addition, the category feature of the image generation device according to the present invention can be trained to be extracted from the second image excluding the unique feature and to be identified by a predetermined identification apparatus as not having the unique feature.

In addition, the generation unit of the image generation device according to the present invention can convert data obtained by applying a mask using location information of a divided region associated with the desired unique feature to the category feature and generate the first image using the data obtained from the conversion.

In addition, the generation unit of the image generation device according to the present invention may further convert, from the desired unique feature, data including data with a reduced amount of location information for the divided region associated with the desired unique feature and the category feature to generate the first image using the data obtained from the conversion.

In addition, the generation unit of the image generation device according to the present invention further includes an encoder configured to use the second image as an input to extract the category feature and a decoder configured to use the category feature and the desired unique feature as an input to generate the first image, and the encoder and the decoder may be trained in advance based on a pair of a training unique feature and a training image having the training unique feature such that, when the training image is input to the encoder and the training unique feature is input to the decoder, the decoder reconfigures the training image and a predetermined identification apparatus that uses the category feature as an input identifies the training image as not having the training unique feature.

In addition, the predetermined identification apparatus of the image generation device according to the present invention can be trained in advance to correctly identify the training image as having the unique feature When the category feature is input.

A program according to the present invention is a program for causing a computer to function as each unit of the image generation device.

### Effects of the Invention

According to the image generation device, the image generation method, and the program of the present invention, an image of a desired category having a desired unique feature can be generated.

### BRIEF DESCRIPTION OF DRAWINGS

FIG. 1 is a block diagram illustrating an example of a configuration of an image generation device according to an embodiment of the present invention.

FIG. 2 is an image diagram illustrating a relationship between an encoder, a decoder, and an identification apparatus of the image generation device according to the embodiment of the present invention.

FIG. 3 is an image diagram illustrating an example of a configuration of the decoder of the image generation device according to the embodiment of the present invention.

FIG. 4 is an example of a first image generated by the image generation device according to the embodiment of the present invention.

FIG. 5 is a flowchart showing a training processing routine of the image generation device according to the embodiment of the present invention.

FIG. 6 is a flowchart showing a decoding processing routine of the image generation device according to the embodiment of the present invention.

FIG. 7 is a flowchart showing an image generation processing routine of the image generation device according to the embodiment of the present invention.

FIG. 8 is an image diagram illustrating a problem to be solved by the present invention.

### DESCRIPTION OF EMBODIMENTS

An embodiment of the present invention will be described with reference to the drawings.

### Configuration of Image Generation Device according to Embodiment of Present Invention

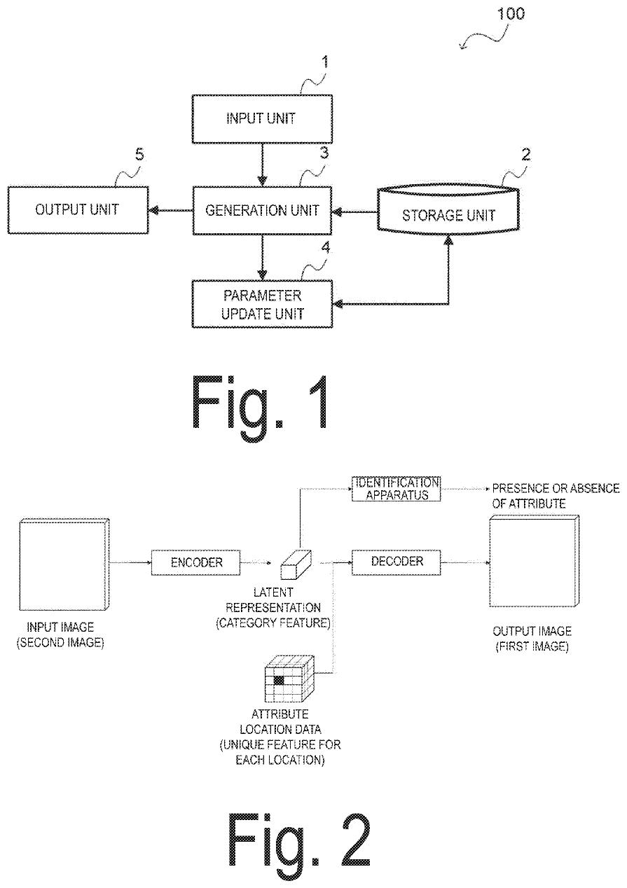

A configuration of an image generation device 100 according to an embodiment of the present invention will be described with reference to FIG. 1. FIG. 1 is a block diagram illustrating a configuration of the image generation device according to an embodiment of the present invention.

The image generation device 100 is configured as a computer including a CPU, a RAM, and a ROM storing a program for executing an image generation processing routine, which will be described below, and is functionally configured as follows.

The image generation device 100 according to the present embodiment includes an input unit 1, a storage unit 2, a generation unit 3, a parameter update unit 4, and an output unit 5 as illustrated in FIG. 1. Hereinafter, functions of the image generation device 100 will be described by dividing processing of the image generation device into training processing and image generation processing.

### Training Process

The input unit 1 receives an input of one or more pairs of a training unique feature and a training image including the training unique feature.

In the present embodiment, a category feature is a feature common to objects belonging to a desired category. For example, a feature of a hat category “hat” is a “round” brim portion.

Furthermore, a unique feature (attribute) is a feature that is not required to be common to a plurality of objects belonging to a desired category. For example, a feature of the hat category “hat” is a feature “being blue.” The feature “being blue” may or may not be common to a plurality of objects belonging to the category “hat.”

In addition, attribute location data is data representing a unique feature (attribute) at each of locations in a first image (output image).

Specifically, a training image x is a tensor having a size of a lateral width x a longitudinal width x a number of channels, and it is assumed here that the lateral width of the training image x is denoted by W, the longitudinal width is denoted by H, and the number of channels is denoted by D. In addition, the training image x may be any tensor having a lateral width and a longitudinal width that are equal to each other (i.e., W=H).

In addition, it is assumed that the coordinates of the channel located at the top left front of the tensor are denoted as (0,0,0), and the coordinates of the channel in an order w-th to the right, h-th to the bottom, and d-th to the depth from the top left front are denoted as (w, h, d).

In addition, to simplify explanation, for each tensor, the dimension of the lateral width is defined as dimension 1, the dimension of the longitudinal width is defined as dimension 2, and the dimension of the number of channels is defined as dimension 3, That is, a size of the training image x in dimension 1 is denoted by W, a size of the training image x in dimension 2 is denoted by H, and a size of the training image x in dimension 3 is denoted by D.

A method of creating an image having a lateral width and a longitudinal width that are equal to each other (W=H) from an image having a lateral width and a longitudinal width that are not equal to each other (W≠H) may be any processing of changing a size of a tensor. Examples of processing of changing a size of a tensor include resizing processing, cropping processing of cutting out a part of an image, padding processing of iteratively adding the numerical value 0 around an image or pixels at the edges of the image, mirroring processing of reversely adding pixels at the edges of the image to the top, bottom, left, and right, and the like.

Unique features are different unique features in images of the same category, and unique features are associated with each of divided regions obtained by dividing a training image.

In the present embodiment, the input unit 1 receives an input of attribute location data y representing an attribute at each of locations as a unique feature. The attribute location data y is data representing an attribute of the training image x at each location after a conversion.

An attribute may be any word representing a unique feature of a pre-defined image to be converted by the image generation device 100, and is a word representing a feature such as a color like red or blue, a material like wood or glass, a pattern like a dot or a stripe, or the like.

Moreover, each attribute is assumed to be given a specifiable identifier. For example, when a pre-defined attribute is an A type, each attribute is given a natural number that is greater than or equal to 0 and less than A. Furthermore, the attribute location data y is assumed to represent the presence or absence of each attribute of the training image x at each location after a conversion.

When an attribute is an A type, it is assumed that the attribute location data y is a tensor Y having a size of M×N×A, and when the size of the training image x is W×H×D, 1≤M≤W and 1≤N≤H are satisfied, and M=N are satisfied.

When the training image x is divided into grid squares by dividing into M pieces over the lateral width and N pieces over the longitudinal width, and a numerical value specifying an attribute of the grid square in an order m-th to the right and n-th to the bottom from the top left of the grid squares of the image after the conversion of the training image x is a, 1 is placed at the location (m, n, a) of a tensor Y.

On the other hand, if the grid does not have the attribute specified by the numerical value a, 0 is placed at the location (m, n, a) of the tensor Y.

Then, the input unit 1 passes one or more pairs of the received training image x and the attribute location data y to the generation unit 3.

The storage unit 2 stores an encoder, a decoder, and an identification apparatus. Here, the encoder uses the training image x as an input to extract a latent representation E(x) as a category feature that is a feature common to images belonging to the same category as that of the training image x. In addition, the decoder uses the latent representation E(x) and the attribute location data y as an input to generate an image having an attribute at each location and belonging to the category. In addition, the identification apparatus uses the latent representation E(x) as an input to identify whether each attribute is included.

Specifically, each of the encoder, the decoder, and the identification apparatus is of a neural network, and parameters of the neural networks are stored in the storage unit 2.

The generation unit 3 generates an output image;
\tilde{X}
   by associating the attribute location data y with the latent representation E(x) obtained from the training image belonging to the same category as that of the output image;
\tilde{X}

Specifically, the generation unit 3 acquires, from the storage unit 2, the parameters of the encoder, the decoder, and the identification apparatus.

Next, the generation unit 3 inputs the training image x to the encoder, extracts the latent representation E(x), inputs the extracted latent representation E(x) and the attribute location data y to the decoder, and thereby generates an output image
\tilde{X}

FIG. 2 illustrates a relationship between the encoder, the decoder, and the identification apparatus.

The encoder may be any neural network that uses the training image x as an input and extracts a category feature from the training image x excluding attribute information. Hereinafter, the present embodiment will be described using a latent representation E(x) as an example of a category feature.

For example, the encoder of Non Patent Literature 3 can be employed. The encoder of Non Patent Literature 3 uses a neural network having the latent representation E(x) to be output in a size of 2×2×512 when the size of an input image is 256×256×3.

The decoder is a neural network that uses the latent representation E(x) and attribute location data y as inputs and generates an image having the same size as that of the training image x and the attribute information of each location appended based on the attribute location data y.

FIG. 3 illustrates a configuration of the decoder. As illustrated in FIG. 3, the decoder performs each piece of processing such as local latent representation pre-processing, local attribute location data pre-processing, local input data integration processing, local decoder processing, global attribute location data pre-processing, global input data integration processing, global decoder processing, and image decoder processing.

A local decoder, a global decoder, and an image decoder are neural networks. The decoder inputs a tensor created by overlaying a tensor that is an output of the local decoder, a tensor that is an output of the global decoder, and the attribute location data y in the direction of dimension 3 to the image decoder to generate the output image
\tilde{X}
   Each piece of processing performed by the decoder will be described below.

The local decoder is a decoder for filtering only a location having an attribute. The local decoder uses the attribute location data y as a mask and converts the latent representation E(x) to focus only on the location with the attribute.

Specifically, the local decoder may be any neural network that uses the following tensor as an input and outputs a tensor having the same size as that of the input tensor. The following tensor refers to a tensor having sizes in dimensions 1 and 2 that are the same as the sizes of the attribute location data y in dimensions 1 and 2, and having a size in dimension 3 that is the same as the size of latent representation E(x) in dimension 3.

The size of the latent representation E(x) is deformed due to the local latent representation pre-processing, the size of the attribute location data y is deformed due to the local attribute location data pre-processing, and the outputs of each piece of the pre-processing are integrated due to the local input data integration processing. Thus, a tensor having the same size as the sizes of the attribute location data y in dimensions 1 and 2 can be input to the local decoder.

Specifically, the local latent representation pre-processing is processing to deform sizes of the latent representation E(x) in dimensions 1 and 2 to create a tensor having sizes the same as those of the attribute location data v in dimensions 1 and 2.

For example, it is assumed that a size of the latent representation E(x) is 2×2×512 and a size of the attribute location data y is 16×16×11. At this time, in the local latent representation pre-processing, processing is performed to deform the size of the tensor of the latent representation E(x) to be 1×1×512, duplicate the tensor 16×16 times in the directions of dimensions 1 and 2, and output a tensor having a size of 16×16×512. Thus, the output of the local latent representation pre-processing is a tensor having a size of 16×16×512.

In addition, the local attribute location data pre-processing is processing to deform the size of the attribute location data y in dimension 3 to create a tensor having the same size as that of the latent representation E(x) in dimension 3.

For example, it is assumed that a size of the latent representation E(x) is 2×2×512 and a size of the attribute location data y is 16×16×11. At this time, in the local attribute location data pre-processing, processing is performed to add the tensor of the attribute location data y in the direction of dimension 3 to form a tensor having a size of 16×16×1, duplicate the tensor 512 times in the direction of dimension 3, and output a tensor having a size of 16×16×512. Thus, the output of the local attribute location data pre-processing is a tensor having a size of 16×16×512.

The local input data integration processing is processing to use as an input the tensor that is the output of the local latent representation pre-processing and the tensor that is the output of the local attribute location data pre-processing to output a tensor having the same size as that of the two input tensors.

For example, in the local input data integration process, processing is performed to multiply the two input tensors to output a tensor having sizes in dimensions 1 and 2 the same as the sizes of the attribute location data y in dimensions 1 and 2 and having a size in dimension 3 the same as the size of the latent representation E(x) in dimension 3.

The global decoder is a decoder for holding a structure of a whole image. The global decoder performs a conversion to hold a structure of a whole image by reducing the amount of the location information of the attribute location data y by reducing in advance the sizes of the attribute location data y in dimensions 1 and 2 and converting the location information with the latent representation E(x).

Specifically, the global decoder may be any neural network that uses as an input a tensor having sizes in dimensions 1 and 2 the same as the sizes of the latent representation E(x) in dimensions 1 and 2 and outputs a tensor having sizes in dimensions 1 and 2 the same as the sizes of the attribute location data y in dimensions 1 and 2.

The tensor output by deforming the size of the attribute location data y in the global attribute location data pre-processing is integrated with the latent representation E(x) in the global input data integration processing. Thus, a tensor having sizes in dimensions 1 and 2 the same as the sizes of the latent representation E(x) in dimensions 1 and 2 can be input to the global decoder.

Specifically, the global attribute location data pre-processing is processing to deform sizes of the attribute location data y in dimensions 1 and 2 to create a tensor having sizes the same as those of the latent representation E(x) in dimensions 1 and 2.

For example, the global attribute location data pre-processing is processing, when a size of the latent representation E(x) is 2×2×512 and a size of the attribute location data y is 16×16×11, for performing convolutional processing with a convolutional neural network to output a tensor having a size of 2×2×512.

The global input data integration processing is processing that uses as an input the latent representation E(x) and the tensor that is the output of the global attribute location data pre-processing and outputs a tensor having sizes in dimensions 1 and 2 the same as the sizes of the two input tensors in dimensions 1 and 2.

For example, in the global input data integration process, processing is performed to overlay the two input tensors in the direction of dimension 3 to output a tensor having sizes in dimensions 1 and 2 the same as the sizes of latent representation in dimensions 1 and 2.

The image decoder receives a tensor obtained by overlaying the tensor that is the output of the local decoder, the tensor that is the output of the global decoder, and the attribute location data y in the direction of dimension 3 as an input and performs processing to generate an output image:
\tilde{X}

The identification apparatus is a neural network that identifies an attribute of an image when an input of the latent representation E(x) obtained from the image is received.

For example, when a size of the latent representation E(x) is 2×2×512 and the number of attributes is 10, the identification apparatus can use a neural network that receives a tensor having a size of 2×2×512 as an input and outputs a vector with a length of 10.

Then, the generation unit 3 passes the training image x, the generated output image
\tilde{X}, and
   the attribute location data y to the parameter update unit 4.

The parameter update unit 4 updates each parameter of the encoder and the decoder and the parameters of the identification apparatus as follows, based on the pair of the attribute location data y and the training image x with the attribute at each location represented by the attribute location data y. Here, each of the parameters of the encoder and decoder is updated such that the decoder reconfigures the training image x when the training image x is input to the encoder and the attribute location data y is input to the decoder and the identification apparatus that uses the latent representation E(x) as an input identifies the training image x as not having an attribute represented by the attribute location data y. Furthermore, parameters of the identification apparatus are updated to correctly identify the training image x as having the attribute represented by the attribute location data y when the latent representation E(x) is input.

Specifically, the parameter update unit 4 acquires, first, the parameters of the encoder, the decoder, and the identification apparatus from the storage unit 2.

Next, the parameter update unit 4 updates each of the parameters of the encoder, the decoder, and the identification apparatus that are neural networks to satisfy the two types of constraints described below.

A first constraint is to update each of the parameters of the encoder and the decoder so that the generated output image
\tilde{X}
   reconfigures the training image x.

Any training method configured to satisfy the first constraint may be used, for example, in Non Patent Literature 3, each of parameters of the encoder and the decoder is updated to calculate and reduce the square error of the training image x and the generated output image
\tilde{X}

A second constraint is to update each of the parameters of the encoder and the identification apparatus such that the encoder that has received the input of the training image x extracts the latent representation E(x) to exclude the attribute information and the identification apparatus correctly identifies the training image as having the attribute represented by the attribute location data y from the latent representation E(x).

A method for updating each parameter may be any training method configured to satisfy the second constraint. For example, in Non Patent Literature 3, a parameter of the encoder is updated such that a probability of the identification apparatus correctly identifying an image from which the E(x) has been obtained as having the attribute represented by the attribute location data y from the latent representation E(x) is reduced. Furthermore, in Non Patent Literature 3, a parameter of the identification apparatus may be updated such that a probability of the identification apparatus identifying an image from which the E(x) has been obtained as having the attribute represented by the attribute location data y from the latent representation E(x) is increased.

Then, the parameter update unit 4 stores each of the trained parameters of the encoder, the decoder, and the identification apparatus in the storage unit 2.

Note that, in the training process, each parameter of the encoder, the decoder, and the identification apparatus may be trained for each of one or more pairs of the input training image x and attribute location data y, or multiple parameters may be trained simultaneously or collectively in batch processing or the like.

### Image Generation Processing

Next, the image generation processing will be described. In the image generation processing of the image generation device 100, a first image
\tilde{X}
   having attribute location data y that is a unique feature is generated.

Note that, for simplicity, a second image x is assumed to be a tensor similar to the training image x in the present embodiment.

The input unit 1 receives an input of the second image x belonging to the same category as the first image
\tilde{X}
   desired to be generated and the attribute location data y which is a desired unique feature.

Specifically, the second image x is a tensor having a size of a lateral width x a longitudinal width x the number of channels, where the lateral width of the second image x is denoted by W, the longitudinal width is denoted by H, and the number of channels is denoted by D. In addition, the second image x may be any tensor having a lateral width and a longitudinal width that are equal to each other (i.e., W=H).

In addition, it is assumed that the coordinates of the channel located at the top left front of the tensor are denoted as (0,0,0), and the coordinates of the channel in an order w-th to the right, h-th to the bottom, and d-th to the depth from the top left front are denoted as (w, h, d).

In addition, to simplify explanation, for each tensor, the dimension of the lateral width is defined as dimension 1, the dimension of the longitudinal width is defined as dimension 2, and the dimension of the number of channels is defined as dimension 3, similarly to the training processing. That is, a size of dimension 1 of the second image x is denoted by W, a size of dimension 2 is denoted by H, and a size of dimension 3 is denoted by D.

A method of creating an image having a lateral width and a longitudinal width that are equal to each other (W=H) from an image having a lateral width and a longitudinal width that are not equal to each other (W≠H) may be any processing of changing a size of a tensor. Examples of processing of changing a size of a tensor include resizing processing, cropping processing of cutting out a part of an image, padding processing of iteratively adding the numerical value 0 around an image or pixels at the edges of the image, mirroring processing of reversely adding pixels at the edges of the image to the top, bottom, left, and right, and the like.

Then, the input unit 1 passes the received second image x and attribute location data y to the generation unit 3.

The storage unit 2 stores each parameter of the encoder, the decoder, and the identification apparatus trained from training processing.

The generation unit 3 generates a first image
\tilde{X}
   by associating the attribute location data y with the latent representation E(x) obtained from the second image x belonging to the same category as that of the first image
\tilde{X}

Specifically, the generation unit 3 acquires, first, the trained parameters of the encoder, the decoder, and the identification apparatus from the storage unit 2.

Next, the generation unit 3 inputs the second image x to the encoder to extract the latent representation E(x), inputs the extracted latent representation E(x) and the attribute location data y to the decoder, and thereby generates the first image
\tilde{X}

Then, the generation unit 3 passes the generated first image
\tilde{X}
   to the output unit 5.

The output unit 5 outputs the first image
\tilde{X}

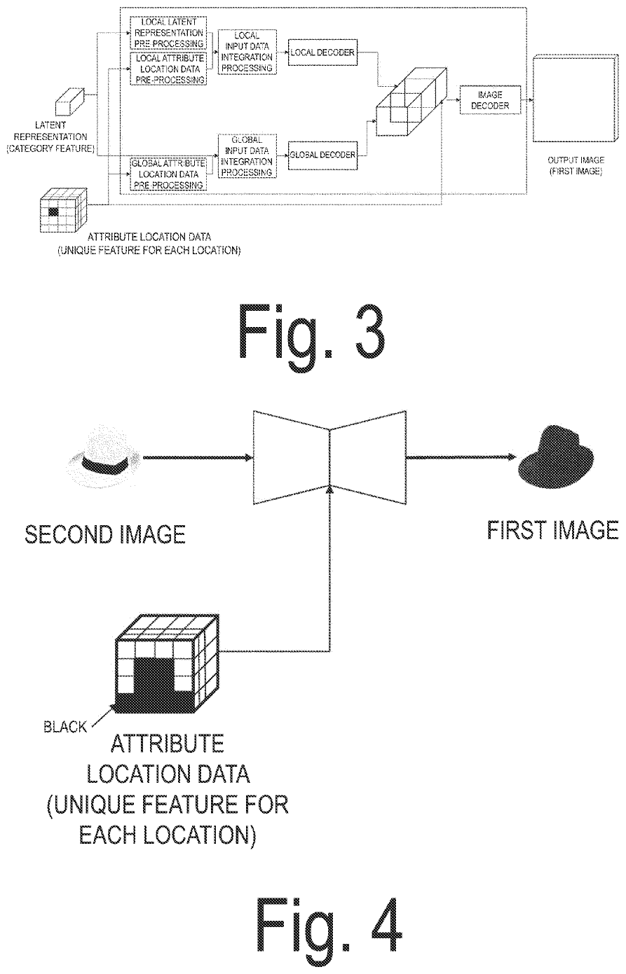

FIG. 4 illustrates an example of the first image generated by the image generation device 100. The example of FIG. 4 illustrates generation of a first image
\tilde{X}
   in which all locations on the hat are black from a second image x belonging to the category “hat” and the attribute location data y representing the locations of the entire target object having the attribute “black.”

This is because, even for a second image of an unknown category, the latent representation E(x) of that category excluding attribute information can be extracted by the encoder that has completed training by the training processing, and an attribute represented by desired attribute location data y can be associated with the extracted latent representation E(x).

By inputting various kinds of attribute location data y to the image generation device 100 according to the present embodiment, it is possible to generate a plurality of first images
\tilde{X}
   of the same category as the second image and having the attribute represented by the attribute location data y.

The plurality of first images generated as described above
\tilde{X}
   can be used as, for example, training images of an object detector.

### Action of Image Generation Device According to Embodiment of Present Invention

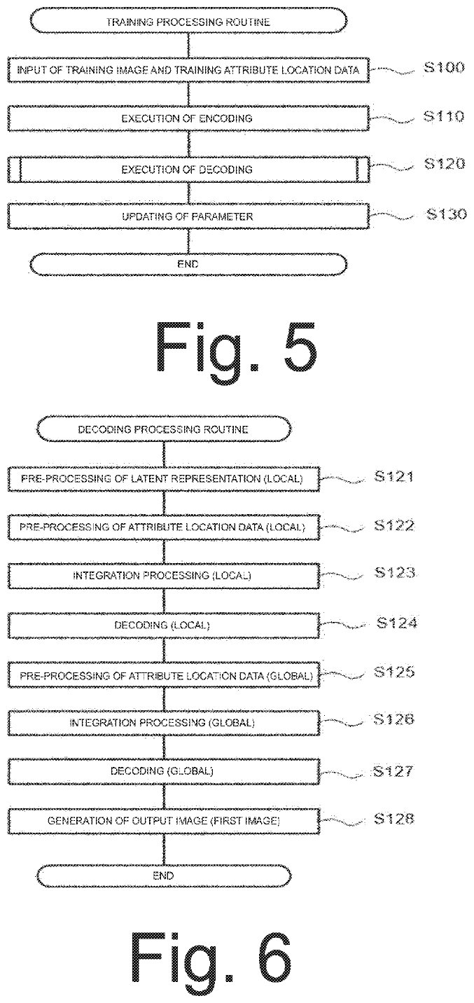

FIG. 5 is a flowchart showing a training processing routine according to the embodiment of the present invention.

When one or more pairs of attribute location data y and the training image x having the attribute represented by the attribute location data y at each location are input to the input unit 1, the image generation device 100 executes the training processing routine illustrated in FIG. 5.

First, in step S100, the input unit 1 receives an input of one or more pairs of the attribute location data y and the training image x.

In step S110, the generation unit 3 inputs the training image x to the encoder to extract the latent representation E(x).

In step S120, the generation unit 3 inputs the latent representation E(x) extracted in step Silo described above and the attribute location data y to the decoder to generate an output image
\tilde{X}

In step S130, the parameter update unit 4 updates each parameter of the encoder and the decoder and parameters of the identification apparatus as follows, based on the pair of the attribute location data y and the training image x haying the attributes of the locations represented by the attribute location data y. Here, each of the parameters of the encoder and decoder is updated such that the decoder reconfigures the training image x when the training image x is input to the encoder and the attribute location data y is input to the decoder and the identification apparatus that uses the latent representation E(x) as an input identifies the training image x as not having an attribute represented by the attribute location data y. Furthermore, parameters of the identification apparatus are updated to correctly identify the training image x as having the attribute represented by the attribute location data y when the latent representation E(x) is input.

FIG. 6 is a flowchart showing the decoding processing routine in step S120 described above.

In step S121, the generation unit 3 performs the local latent representation pre-processing to deform sizes of the latent representation E(x) in dimensions 1 and 2 to create a tensor having sizes the same as those of the attribute location data y in dimensions 1 and 2.

In step S122, the generation unit 3 performs the local attribute location data pre-processing to deform the size of the attribute location data y in dimension 3 to create a tensor having a size the same as that of the latent representation E(x) in dimension 3.

In step S123, the generation unit 3 performs the local input data integration processing in which the tensor obtained in the above step S121 and the tensor obtained in the above step S122 are used as an input and a tensor having the same size as that of the input two tensors is output.

In step S124, the generation unit 3 inputs the tensor obtained in the above step S124 to the local decoder, uses the attribute location data y as a mask, and converts the latent representation E(x) so as to focus only on the location having the attribute.

In step S125, the generation unit 3 performs the global attribute location data pre-processing to deform the sizes of the attribute location data y in dimensions 1 and 2 to create a tensor having sizes the same as those of the category feature in dimensions 1 and 2.

In step S126, the generation unit 3 performs a global input data integration process in which the latent representation F(x) and the tensor obtained in the above step S125 are used as an input, and a tensor having sizes in dimensions 1 and 2 the same as the sizes of the two input tensors in dimensions 1 and 2 is output.

In step S127, the generation unit 3 inputs the tensor obtained in the above step S126 to the global decoder, reduces the amount of location information for the attribute location data y, and converts the tensor to maintain the overall structure of the image by converting it with the latent representation E(x).

In step S128, the generation unit 3 inputs a tensor created by overlaying the tensor decoded in the above step S124, the tensor decoded in the above step S127, and the attribute location data y in the direction of dimension 3 to the image decoder to generate an output image
\tilde{X}

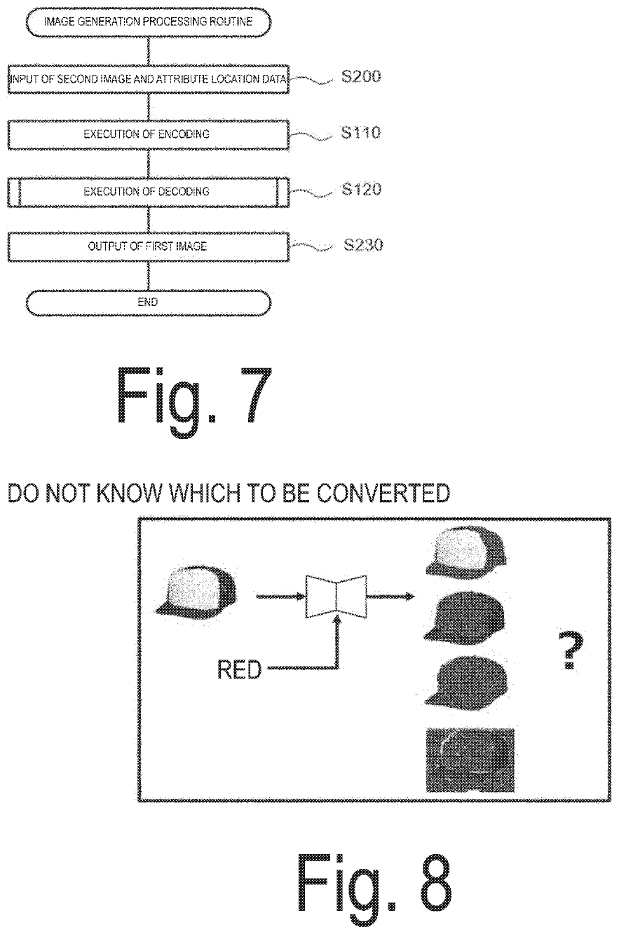

FIG. 7 is a flowchart showing an image generation processing routine according to the embodiment of the present invention. Note that processing similar to that of the training processing routine will be given the same reference signs, and detailed descriptions thereof will be omitted.

When the second image x and the attribute location data y are input to the input unit 1, the image generation processing routine illustrated in FIG. 7 is executed in the image generation device 100.

First, in step S200, the input unit 1 receives an input of the second image x belonging to the same category as the generated first image
\tilde{X}
   desired to be generated and the attribute location data y.

In step S230, the output unit 5 outputs the first image
\tilde{X}
   obtained in the above step S120. Note that, in step S128 in the image generation processing, the generation unit 3 has generated the first image
\tilde{X}

As described above, the image generation device according to the embodiment of the present invention can generate a first image by associating the category feature with the unique feature, and thus can generate an image of a desired category having a desired unique feature. Here, the category feature is a feature common to images belonging to the category obtained from a second image belonging to the same category as the first image. Also, the unique feature is a unique feature that is different between the first image and the second image.

Note that the present invention is not limited to the above-described embodiment, and various modifications and applications may be made without departing from the gist of the present invention.

Although the training processing and the image generation processing are performed by the same image generation device 100 in the present embodiment, the processing may be performed by another device. In this case, it is only required to user the storage unit 2 storing the encoder, the decoder, and the identification apparatus that have completed training by the training processing in the image generation processing.

In addition, although an embodiment in which the programs are installed in advance has been described in the present specification of the present application, such programs can be provided by being stored in a computer-readable recording medium.

### REFERENCE SIGNS LIST

1 Input unit

2 Storage unit

3 Generation unit

4 Parameter update unit

5 Output unit

100 Image generation device

1. An image generation device configured to generate a first image having a desired unique feature, the image generation device comprising:
a generator configured to generate the first image by associating a category feature that is a feature common to images belonging to a category obtained from a second image belonging to the same category as that of the first image with a unique feature that is a unique feature different between the first image and the second image,
wherein the unique feature is associated with the desired unique feature for a divided region obtained by dividing the second image.

2. The image generation device according to claim 1,
wherein the category feature is trained to be extracted from the second image excluding the unique feature and to be identified by a predetermined identification apparatus as not having the unique feature.

3. The image generation device according to claim 1,
wherein the generator is configured to convert data obtained by applying a mask using location information of a divided region associated with the desired unique feature to the category feature and generate the first image using the data obtained from the conversion.

4. The image generation device according to claim 3,
wherein the generator further converts, from the desired unique feature, data including data with a reduced amount of location information for the divided region associated with the desired unique feature and the category feature to generate the first image using the data obtained from the conversion.

5. The image generation device according to claim 1, wherein the generator further includes:
an encoder configured to use the second image as an input to extract the category feature, and
a decoder configured to use the category feature and the desired unique feature as an input to generate the first image, wherein the encoder and the decoder are trained in advance based on a pair of a training unique feature and a training image having the training unique feature such that, when the training image is input to the encoder and the training unique feature is input to the decoder, the decoder reconfigures the training image and a predetermined identification apparatus that uses the category feature as an input identifies the training image as not having the training unique feature.

6. The image generation device according to claim 5,
wherein the predetermined identification apparatus is trained in advance to correctly identify the training image as having the unique feature when the category feature is input.

7. An image generation method for generating a first image having a desired feature, the image generation method comprising:
generating, by a generator, the first image by associating a category feature that is a feature common to images belonging to a category obtained from a second image belonging to the same category as that of the first image with a unique feature that is a unique feature different between the first image and the second image,
wherein the unique feature is associated with the desired unique feature for a divided region obtained by dividing the second image.

8. A computer-readable non-transitory recording medium storing a computer-executable program instructions that when executed by a processor cause a computer system to:
generate, by a generator, a first image by associating a category feature that is a feature common to images belonging to a category obtained from a second image belonging to the same category as that of the first image with a unique feature that is a unique feature different between the first image and the second image,
wherein the unique feature is associated with the desired unique feature for a divided region obtained by dividing the second image.

9. The image generation device according to claim 5,
wherein the category feature is trained to be extracted from the second image excluding the unique feature and to be identified by a predetermined identification apparatus as not having the unique feature, and
wherein the generator is configured to convert data obtained by applying a mask using location information of a divided region associated with the desired unique feature to the category feature and generate the first image using the data obtained from the conversion.

10. The image generation method according to claim 7, wherein the category feature is trained to be extracted from the second image excluding the unique feature and to be identified by a predetermined identification apparatus as not having the unique feature.

11. The image generation method according to claim 7, wherein the generator is configured to convert data obtained by applying a mask using location information of a divided region associated with the desired unique feature to the category feature and generate the first image using the data obtained from the conversion.

12. The image generation method according to claim 11, wherein the generator further converts, from the desired unique feature, data including data with a reduced amount of location information for the divided region associated with the desired unique feature and the category feature to generate the first image using the data obtained from the conversion.

13. The image generation method according to claim 7, wherein the generator further includes:
an encoder configured to use the second image as an input to extract the category feature, and
a decoder configured to use the category feature and the desired unique feature as an input to generate the first image, wherein the encoder and the decoder are trained in advance based on a pair of a training unique feature and a training image having the training unique feature such that, when the training image is input to the encoder and the training unique feature is input to the decoder, the decoder reconfigures the training image and a predetermined identification apparatus that uses the category feature as an input identifies the training image as not having the training unique feature.

14. The image generation method according to claim 13, wherein the predetermined identification apparatus is trained in advance to correctly identify the training image as having the unique feature when the category feature is input.

15. The image generation method according to claim 13,
wherein the category feature is trained to be extracted from the second image excluding the unique feature and to be identified by a predetermined identification apparatus as not having the unique feature, and
wherein the generator is configured to convert data obtained by applying a mask using location information of a divided region associated with the desired unique feature to the category feature and generate the first image using the data obtained from the conversion.

16. The computer-readable non-transitory recording medium according to claim 8, wherein the category feature is trained to be extracted from the second image excluding the unique feature and to be identified by a predetermined identification apparatus as not having the unique feature.

17. The computer-readable non-transitory recording medium according to claim 8, wherein the generator is configured to convert data obtained by applying a mask using location information of a divided region associated with the desired unique feature to the category feature and generate the first image using the data obtained from the conversion.

18. The computer-readable non-transitory recording medium according to claim 17, wherein the generator further converts, from the desired unique feature, data including data with a reduced amount of location information for the divided region associated with the desired unique feature and the category feature to generate the first image using the data obtained from the conversion.

19. The computer-readable non-transitory recording medium according to claim 8, wherein the generator further includes:
an encoder configured to use the second image as an input to extract the category feature, and
a decoder configured to use the category feature and the desired unique feature as an input to generate the first image, wherein the encoder and the decoder are trained in advance based on a pair of a training unique feature and a training image having the training unique feature such that, when the training image is input to the encoder and the training unique feature is input to the decoder, the decoder reconfigures the training image and a predetermined identification apparatus that uses the category feature as an input identifies the training image as not having the training unique feature.

20. The computer-readable non-transitory recording medium according to claim 19,
wherein the predetermined identification apparatus is trained in advance to correctly identify the training image as having the unique feature when the category feature is input,
wherein the category feature is trained to be extracted from the second image excluding the unique feature and to be identified by a predetermined identification apparatus as not having the unique feature, and
wherein the generator is configured to convert data obtained by applying a mask using location information of a divided region associated with the desired unique feature to the category feature and generate the first image using the data obtained from the conversion.
